(19) United States
(12) Patent Application Publication
(10) Pub. No.: US 2008/0087286 A1
(43) Pub. Date: Apr. 17, 2008

(54) Disposable nasal filter

(76) Inventor: James Jones, Chesapeake, VA (US)

Correspondence Address: R. J. Lasker, Esq.;Transpotomac Plaza, Bldg. 5, Suite 900, 1199 North Fairfax Street, Alexandria, VA, 22314, US

(21) Appl. No.: 11/545,519

(22) Filed: Oct. 11, 2006

(51) Int. Cl. A62B 23/02

(52) U.S. Cl. 128/206.11

(57) ABSTRACT

A disposable nasal filter for filtering air breathed into the respective nostrils of a nose with a semi-circular ring member having respective end portions in the form of cup-like members forming a clip for engagement with respective opposing inner portions of the bridge of a nose; and respective filter members attached to opposite sides of the ring member for covering the respective nostrils of the nose to filter the air entering the nostrils.

### BACKGROUND OF THE INVENTION

1. Field of the Invention

The present invention relates to a nasal particle filtering device used to minimize particle intake, nasal and respiratory agitation and to increase the quality of the air breathed through the nasal passages of the wearer; and, in particular, to such a nasal particle filter that does not enter the nasal passage of the wearer and includes a simple clip design that attaches to the inside of the nasal opening, thereby reducing the aggravation to the wearer in using the nasal particle filtering device of the invention.

2. Description of Related Art

Filter masks that are attached to the nose are known to the art. Many such masks are worn to purify the impure air that is passing into the lungs. Such masks usually fit over the mouth and nose and are held in place by a string or by some other type of holding device that goes around the head. These masks can increase body heat, are uncomfortable to wear and therefore cause discomfort. Such masks also inhibit other activities from being performed such as eating, drinking or talking.

There are also filters that contain removable or exchangeable filter elements, filters that filter fumes, filters that adhere to the skin and varying other filters that are inserted into the nose such as variously described in the following U.S. Pat. Nos. 6,494,205, 6,971,387, 6,701, 924, 6,216,694, 5,890,491, 5,568,808, and 5,485,836.

While the above mentioned filters may perform their particular filtering purposes, they describe a filter that is partially or totally intrusive and significantly one that is designed to provide a different service than the filter of the present invention. Additionally, the mask-like filters as well as the inserted filters are different in some aspect from the present invention and they also have distinct disadvantages from the present invention such as being highly visible, a different type of attachment, type of design resulting in discomfort, inability to maintain adhesiveness and proper positioning, contorted shapes, dislodging and over insertion possibility, irritation, unnecessary face coverage, improper sealing and fitting. In particular, known nasal filters are prone to irritate the wearer for the simple reason that they are required to at least partially enter the nasal passage of the wearer and therefore cause undue irritation.

### SUMMARY OF THE INVENTION

In view of the foregoing inadequacies and deficiencies of the aforementioned prior known nasal filtering devices there is a need to supply a particle filter that is designed to enhance the quality of air breathed primarily for the use of barbers and a nasal filter that departs from the concept, design and purpose of the former nasal filter devices. While the nasal filter of the present invention serves the general purpose of filtering particles from the nasal passages, because of its design it can be used for other particle filtering purposes. An additional benefit of this invention is that it is disposable and inexpensive to manufacture. The nasal device of this invention is small and the filter portion of the nasal device fits entirely outside the nasal opening. The inventive nasal device is a single one piece unit and has a simple flexible clip design to attach to the inside of the nasal opening. The filter screen portion of the nasal device imitates the natural opening of the nasal passage and is made of a miniature cross section material or cloth-like material which prevents inhalation of particles and to allow proper air flow into and out of the nasal passages.

A further advantage of this invention is that it allows the wearer to perform a better service because of the minimization of the fears associated with particle inhalation and discontinuation of service due to respiratory agitations and ailments caused by inhalation of hair particles.

Yet a further advantage of this invention is that because of its low visibility, it minimizes the chance of embarrassment because of its use, it is easy to apply and it is of simple design. The nasal filter of the present invention also encourages the use of filtering and thereby alleviates some of the affects that are created from nonuse of such nasal filter devices.

### BRIEF DESCRIPTION OF THE DRAWING

The above objects, features and advantages of the invention are believed to be readily apparent from the following description of a preferred embodiment of the best mode of carrying out the invention when taken in conjunction with the following description and the drawings, wherein:

FIG. 1 illustrates a perspective view of the disposable nasal filter of the invention wherein an attachment portion of the filter comprises a semicircular shaped ring having a cuplike clip at each open end of the ring for attachment to the inside bridge of the nose and filter screen attached to each side of the ring to cover the nasal opening of the wearer; and

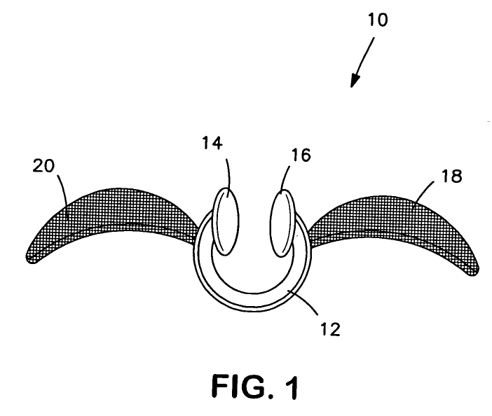

FIG. 2 shows the disposable nasal filter inserted in the nasal cavities of an individual.

### DETAILED DESCRIPTION OF THE INVENTION

The disposable nasal filter 10 of the invention comprises a semicircular-shaped ring portion 12 made of a substance that retains it shape when stretched as the filter is attached to the inside bridge of the nose (not shown) by cuplike clips 14, 16 attached to each open end of the ring 12. Such a material is preferably hard rubber or plastic. Each of the cuplike clips 14, 16 is preferably made of a rubber composition that enables it to form a suction cup that will enable it to adhere to the outside of the nasal passage on each side of the nasal bridge. Other satisfactory materials are plastic, neoprene, silicone, flexible metal, or other elastic material.

A filter screen is formed at each side of the ring 12 below each end of the ring and is adapted to mold to the outside of the nasal passage. Each of the filter screens 18, 20 are preferably made of soft rubber to mold to the outside of each of the nasal passage. Other suitable materials are silicone, cotton, nylon, metal, plastic, protective cloth-like material or other similar flexible material. As mentioned above, a significant feature of the disposable nose clip of the invention is that the filter screens do not enter the respective nasal passages of the person wearing the disposable nose clip, thereby reducing any discomfort to the wearer of penetration of the filter screens into the respective nasal passages.

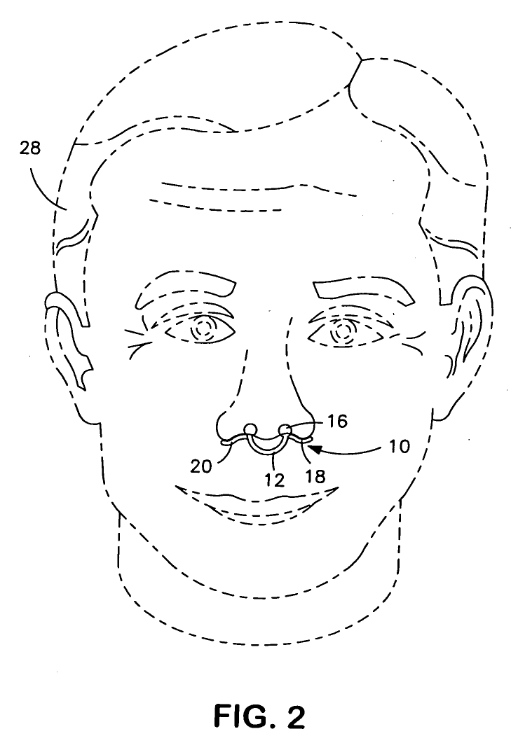

With reference to FIG. 2, the nasal filter 10 is shown inserted in the nasal cavities of an individual wherein clip 16 firmly grasps the inside of the respective nasal passages so that each of the filter screens 18 and 20 effectively cover the respective nasal openings thereby preventing entry of dust and other deleterious material into the nasal passages.

Although it is readily apparent that the size of the various components of the disposable nasal filter of the invention is determined by the size of the nose and nasal passages to which the nasal filter is to be attached a significant advantage of the present invention is that it is designed such that one size fits all reasonable dimensions of the noses of potential users of the disposable nose filter.

The various component parts are preferably attached to one another by gluing, sewing, heat fusing or taping.

Therefore in view of the foregoing description of a preferred embodiment of the invention it is desired that the present invention not be limited to the embodiments specifically described, but that it include any and all such modifications and variations that would be obvious to those skilled in this art of nasal filtering. It is our intention that the scope of the present invention should be determined by any and all such equivalents of the various terms and structure as recited in the following annexed claims.

What is claimed is:

1. A disposable nasal filter for filtering air breathed into the respective nostrils of a nose, comprising:
a semi-circular ring member having respective end portions in the form of cup-like members forming a clip for engagement with respective opposing inner portions of the bridge of a nose; and
respective filter members attached to opposite sides of said ring member for covering the respective nostrils of the nose to filter the air entering the nostrils.

2. A disposable nasal filter as claimed in claim 1, wherein the size of said ring member and said filter members are determined by the size of the nose and the nostrils of the nose.

3. A disposable nasal filter as claimed in claim 1, wherein the ring member is made of material from the group consisting of plastic, rubber, neoprene, silicone, flexible metal, and elastic material and the end portions are made of material from the group consisting of silicone, cotton, nylon, foam, metallic material, plastic, protective cloth or cloth-like material and flexible material.

4. A disposable nasal filter as claimed in claim 1, wherein the respective filter members are attached to the ring member by glue.

5. A disposable nasal filter as claimed in claim 1, wherein the respective filter members are attached to the ring member by heat fusion.

6. A disposable nasal filter as claimed in claim 1, wherein the respective filter members are attached to the ring member by sewing.

7. A disposable nasal filter as claimed in claim 1, wherein the respective filter members are attached to the ring member by tape.
